(19) United States
(12) Patent Application Publication
(10) Pub. No.: US 2023/0229393 A1
(43) Pub. Date: Jul. 20, 2023

(54) ACCUMULATION DEVICE AND METHOD, AND READABLE STORAGE MEDIUM

(71) Applicant: CAMBRICON (XI'AN) SEMICONDUCTOR CO., LTD., Shaanxi (CN)

(72) Inventors: Enhe LIU, Shaanxi (CN); Qi LI, Shaanxi (CN); Boyu QIAN, Shaanxi (CN); Shaoli LIU, Shaanxi (CN); Jun LIANG, Shaanxi (CN)

(21) Appl. No.: 18/013,398

(22) PCT Filed: Sep. 23, 2021
(86) PCT No.: PCT/CN2021/119947

§ 371 Date: Dec. 28, 2022

(30) Foreign Application Priority Data
Nov. 27, 2020 (CN) 202011364680.7

(51) Int. Cl. G06F 7/485

(52) U.S. Cl. CPC G06F 7/485

(57) ABSTRACT

An accumulation apparatus according to an embodiment accumulates a plurality of floating point numbers in an identification cluster. A base exponent is identified, and, then, an accumulation cluster is filtered according to the base exponent, and floating point numbers in the accumulation cluster are accumulated. A small circuit area, low power consumption, and high precision can be achieved.

### CROSS REFERENCE OF RELATED APPLICATION

This application claims benefit under 35 U.S.C. 119, 120, 121, or 365(c), and is a National Stage entry from International Application No. PCT/CN2021/119947, filed Sep. 23, 2021, which claims priority to the benefit of Chinese Patent Application No. 202011364680.7 filed in the Chinese Intellectual Property Office on Nov. 27, 2020, the entire contents of which are incorporated herein by reference.

### BACKGROUND

### 1. Technical Field

The present disclosure generally relates to a computer field. More specifically, the present disclosure relates to an accumulation apparatus, a method, and a readable storage medium.

### 2. Background Art

Computers are often required to perform floating point number accumulation, which is completed by using a multi-level accumulation tree. Taking accumulation of eight floating point numbers as an example, a first level requires four adders to add the eight floating point numbers pairwise to obtain four numbers. A second level requires two adders to add the four numbers pairwise to obtain two numbers. A third level requires one adder to add the two numbers to obtain a final accumulation result. The layout area of this kind of accumulation tree is large, and the precision of this kind of accumulation tree is not ideal.

Moreover, in some special applications, such as a convolution layer and a fully connected layer of a neural network, it is required to quantize a result after the floating point number accumulation into a fixed point number and then input the fixed point number to a Wallace tree for multiplication. The result of the aforementioned accumulation tree is still a floating point number and is also required to be converted into the fixed point number to be accepted by the Wallace tree, which is not friendly to the consistency of operation.

Therefore, an effective floating point number accumulation solution is urgently required.

### SUMMARY

In order to at least partly solve technical problems mentioned in BACKGROUND, a solution of the present disclosure provides an accumulation apparatus, a method, and a readable storage medium.

A first aspect of the present disclosure discloses an accumulation apparatus, which is configured to accumulate a plurality of floating point numbers in an identification cluster, where each floating point number is represented by an exponent and a mantissa. The accumulation apparatus includes an identification unit, a filtering unit, and an addition unit. The identification unit is configured to identify a base exponent, where the base exponent is a maximum value among exponents of the plurality of floating point numbers. The filtering unit is configured to filter an accumulation cluster according to the base exponent, where the accumulation cluster is a subset of the identification cluster. The addition unit is configured to perform accumulation on floating point numbers in the accumulation cluster.

A second aspect of the present disclosure discloses a method for accumulating a plurality of floating point numbers in an identification cluster, where each floating point number is represented by an exponent and a mantissa. The method includes: identifying a base exponent, where the base exponent is a maximum value among exponents of the plurality of floating point numbers; filtering an accumulation cluster according to the base exponent, where the accumulation cluster is a subset of the identification cluster; and performing accumulation on floating point numbers in the accumulation cluster.

A third aspect of the present disclosure discloses a computer readable storage medium, on which computer program codes for accumulating a plurality of floating point numbers are stored. When the computer program codes are run by a processing apparatus, the method is performed.

The present disclosure has a small circuit area, low power consumption, and high precision.

### BRIEF DESCRIPTION OF THE DRAWINGS

By reading the following detailed description with reference to drawings, the above-mentioned and other objects, features and technical effects of exemplary implementations of the present disclosure will become easier to understand. In the drawings, several implementations of the present disclosure are shown in an exemplary manner rather than a restrictive manner, and the same or corresponding reference numerals indicate the same or corresponding parts.

FIG. 1 shows a sequence of a single-precision floating point number.

FIG. 2 shows a schematic diagram of an accumulation apparatus according to an embodiment of the present disclosure.

FIG. 3 shows a schematic diagram of an identification unit according to an embodiment of the present disclosure.

FIG. 4 shows a schematic diagram of a filtering unit according to an embodiment of the present disclosure.

FIG. 5 shows a schematic diagram of an addition unit according to an embodiment of the present disclosure.

FIG. 6 shows a schematic diagram of a five-level Wallace tree adder according to an embodiment of the present disclosure.

FIG. 7 shows a flowchart of a method for accumulating a plurality of floating point numbers according to an embodiment of the present disclosure.

FIG. 8 shows a flowchart of filtering an accumulation cluster according to an embodiment of the present disclosure.

FIG. 9 shows a flowchart of performing accumulation on floating point numbers according to an embodiment of the present disclosure.

### DETAILED DESCRIPTION

Technical solutions in embodiments of the present disclosure will be described clearly and completely hereinafter with reference to drawings in the embodiments of the present disclosure. Obviously, embodiments to be described are merely some of, but not all of the embodiments of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” in the claims, the specification, and the drawings of the present disclosure are used for distinguishing different objects rather than describing a specific order. Terms such as “including” and “comprising” used in the specification and the claims of the present disclosure indicate the presence of a feature, an entity, a step, an operation, an element, and/or a component, but do not exclude the existence or addition of one or more other features, entities, steps, operations, elements, components, and/or collections thereof.

It should also be understood that terms used in the specification of the present disclosure are merely for a purpose of describing a particular embodiment rather than limiting the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims of the present disclosure refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context.

Specific implementations of the present disclosure will be described in detail in combination with drawings below.

A format for expressing a floating point number in a computer is specified in IEEE 754. Floating point number accumulation is a common basic operation in a computer field. Especially, after entering the era of artificial intelligence, a lot of accumulation operations are required in a convolution layer and a fully connected layer of a neural network. Taking a 32-bit single-precision floating point number as an example, the single-precision floating point number is composed of a 1-bit sign bit (sign), an 8-bit exponent bit (exp), and a 23-bit mantissa bit (mantissa). The single-precision floating point number is arranged into a sequence shown in FIG. 1 to represent a following numerical value:

$$\text{Numerical value= sign} \times \text{mantissa} \times {\text{2}}^{\text{exp-127}}$$

The exponent bit has eight bits and may represent a range from 0 to 255, which may make the exponent very large. Therefore, IEEE 754 specifies an exponent offset as 127, which may make the range of the exponent shift and fall between -127 and 128. Such a range is more reasonable. IEEE 754 further agrees that there is an implicit bit to the left of a decimal point. Generally, this bit is 1. Therefore, the mantissa bit of the aforementioned single-precision floating point number has 24 bits actually.

Taking a case where a decimal number 176.0625 is converted into a binary floating point number as an example, 176.0625 is split into an integer bit “176″ and a decimal bit “0.0625” for conversion respectively. The integer bit “176” is converted into a binary “10110000”, which is 2⁷+2⁵+2⁴=127. The conversion of the decimal bit is to multiply a decimal part by 2 and then take an integer part until a decimal part of a product is 0. In other words, 0.0625×2 = 0.125, and the integer part is 0; next, 0.125×2 = 0.25, and the integer part is still 0; then, 0.25×2 = 0.50, and the integer part is still 0; and finally, 0.5×2 = 1.0, and the integer part is 1. Therefore, the decimal part “0.0625” is converted into a binary “0001”. Therefore, the decimal number 176.0625 is converted into a binary single-precision floating point number “10110000.0001”. When expressed in an exponential form, the binary single-precision floating point number is 1.01100000001×2⁷.

Since IEEE 754 agrees that a single-precision exponent offset is 127, when 1.01100000001×2⁷ is expressed in accordance with IEEE 754 standard, the exponent offset is 7+127=134, which is 10000110, and the mantissa is 01100000001000000000000. Moreover, 176.0625 is a positive number, so the sign bit is 0. To sum up, each numerical value of a single-precision floating point number (FB32) under the IEEE 754 standard converted from the decimal number 176.0625 is shown in FIG. 1.

Since the above representation method limits the range and precision of the floating point number, the floating point number may only be represented approximately for operations, so rounding shall be considered. For decimal, assuming that two decimal places are intended to be retained, which means that a decile and a percentile are retained, a guard bit is the lowest bit of the numerical value, which is the percentile, and a round bit is a first bit to be rounded, which is a ten percentile. All bits after the ten percentile are collectively known as a sticky bit. Information of the sticky bit is all lost. For binary, if two decimal places are intended to be retained, a second bit to the right of the decimal point is the guard bit, a third bit to the right of the decimal point is the round bit, and all decimal bits from a fourth bit to the right of the decimal point belong to the sticky bit.

Therefore, IEEE 754 defines four different rounding methods, including round-to-even, round-to-zero, round down, and round up. IEEE 754 adopts the round-to-even by default. The round-to-even is to round to the nearest value. If the nearest value is unique, the round-to-even is to directly round to the nearest value. If the floating point number happens to be an “intermediate value”, the round-to-even depends on whether the guard bit is an even number. If the guard bit is the even number, bits after the guard bit are directly rounded off and there is no carry. If the guard bit is an odd number, the bits after the guard bit are rounded off after carry.

For the requirements of operations, a floating point number may be represented by using an original code, an inverse code, or a complement. The original code is in the form of sign bit plus true value, which is the representation method shown in FIG. 1. However, when the floating point number is represented by the inverse code, for a positive number, the inverse code is the same as the original code, and for a negative number, the inverse code is to reverse the original code bit by bit, except for the sign bit. When the floating point number is represented by the complement, for the positive number, the complement is the same as the original code, and for the negative number, the complement is to add 1 to the last bit of the inverse code.

When floating point numbers are added, exponent alignment is required first. The exponent alignment refers to an operation of aligning exponents of two floating point numbers that are to be operated. The purpose of the exponent alignment is to enable mantissas of the two floating point numbers to be added. Only when exponent value parts of the two floating point numbers are the same, the same exponent value may be taken out as a common factor, and then the mantissas may be added.

A specific method for the exponent alignment is to calculate a difference value between exponents of the two floating point numbers, add the smaller exponent to the difference value to make the smaller exponent equal to the larger exponent, and simultaneously, shift a mantissa of a floating point number corresponding to the smaller exponent to the right by corresponding bits, so as to ensure that a value of the floating point number remains the same. It is required to be noted that a principle of the exponent alignment is to align the smaller exponent with the larger exponent. The reason is that, if the larger exponent is aligned with the smaller exponent, a high bit of a mantissa of a floating point number corresponding to the larger exponent will be removed. The amount of information of the high bit is large, so removing the high bit leads to more precision loss. In contrast, if the smaller exponent is aligned with the larger exponent, a low bit of a mantissa of a floating point number corresponding to the smaller exponent will be removed. The amount of information of the low bit is small, so removing the low bit leads to less precision loss.

An embodiment of the present disclosure shows an accumulation apparatus for accumulating a plurality of floating point numbers. These floating point numbers that are required to be accumulated constitute an identification cluster in this embodiment. This accumulation apparatus finds out a maximum value among exponents (exponent bits) of these floating point numbers first. Then, the accumulation apparatus filters an accumulation cluster by taking an exponent with the maximum value as a base exponent. Exponent bit numbers of the floating point numbers in the accumulation cluster are relatively close, and the floating point numbers may be directly accumulated without affecting precision. Therefore, this embodiment directly accumulates the floating point numbers in the accumulation cluster and updates the floating point numbers in the identification cluster after the accumulation, and so on until all the floating point numbers are accumulated.

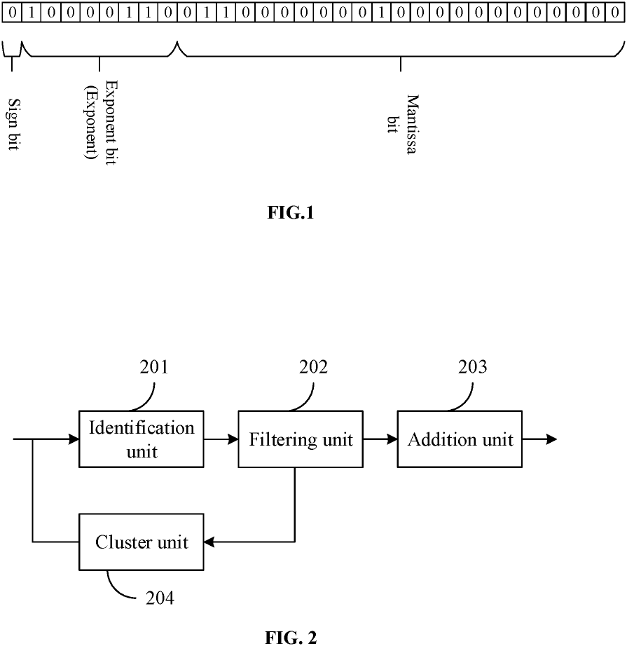

FIG. 2 shows a schematic diagram of the accumulation apparatus of this embodiment. The accumulation apparatus includes an identification unit 201, a filtering unit 202, an addition unit 203, and a cluster unit 204.

The identification unit 201 is configured to identify a base exponent, where the base exponent is a maximum value among exponents of a plurality of floating point numbers. In other words, the identification unit 201 is configured to find out a maximum value among exponents of all floating point numbers in an identification cluster and use this exponent with the maximum value as the base exponent. The filtering unit 202 is configured to compare the base exponent with the exponents of all the floating point numbers in the identification cluster. If a difference value between an exponent and the base exponent is within a certain range, the exponent is filtered into an accumulation cluster. Therefore, the accumulation cluster is a subset of the identification cluster. The addition unit 203 is configured to perform accumulation on floating point numbers in the accumulation cluster. The cluster unit 204 is configured to move the floating point numbers in the accumulation cluster out of the identification cluster after the accumulation and clear the accumulation cluster. The identification unit 201, the filtering unit 202, and the addition unit 203 find out the base exponent based on the identification cluster updated, filter the accumulation cluster, and perform the accumulation on the floating point numbers in the accumulation cluster again until all the floating point numbers are accumulated.

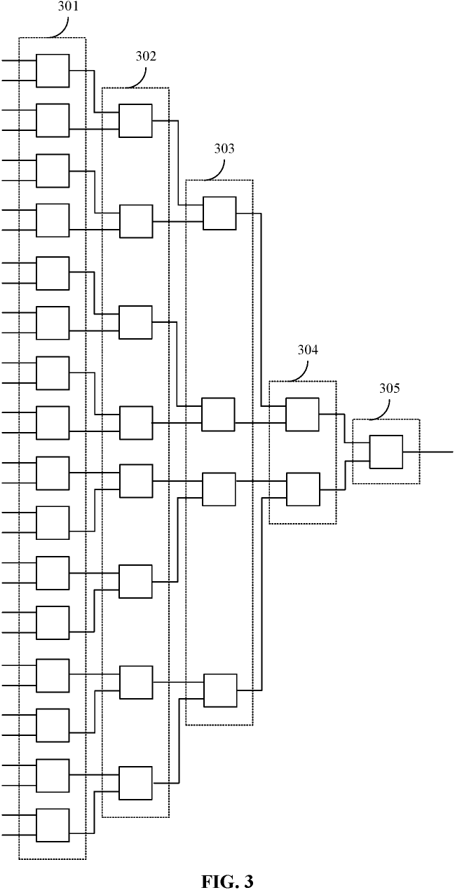

In order to identify the base exponent, the identification unit 201 includes multiple levels of two-input comparators. FIG. 3 shows an implementation sample of the identification unit. The identification unit includes five levels of two-input comparators, which are used to compare sizes of exponents of 32 floating point numbers simultaneously. The five levels of two-input comparators include a first-level comparison unit 301, a second-level comparison unit 302, a third-level comparison unit 303, a fourth-level comparison unit 304, and a fifth-level comparison unit 305. Each level of comparison unit includes a plurality of two-input comparators to compare exponents of floating point numbers pairwise and output the larger exponent to a comparator of a next level. More specifically, the first-level comparison unit 301 may compare sizes of exponents of 32 floating point numbers at a time and output 16 larger ones to the second-level comparison unit 302. The second-level comparison unit 302 receives and compares sizes of exponents of these 16 floating point numbers and outputs 8 larger ones to the third-level comparison unit 303. The third-level comparison unit 303 receives and compares sizes of exponents of these 8 floating point numbers and outputs 4 larger ones to the fourth-level comparison unit 304. The fourth-level comparison unit 304 receives and compares sizes of exponents of these 4 floating point numbers and outputs 2 larger ones to the fifth-level comparison unit 305. The fifth-level comparison unit 305 receives and compares sizes of exponents of these 2 floating point numbers and outputs the larger finally. The output of the fifth-level comparison unit 305 is the largest among the exponents of these 32 floating point numbers.

FIG. 3 is an example of five levels of two-input comparators that may compare sizes of exponents of 32 floating-point numbers at a time. The present disclosure does not limit a structure of the identification unit 201. Those skilled in the art may make appropriate changes according to actual situations. For example, a comparator for selecting one number from eight numbers may be set, and floating point numbers in the identification cluster may be compared by taking eight floating point numbers as one group to find out the base exponent in order.

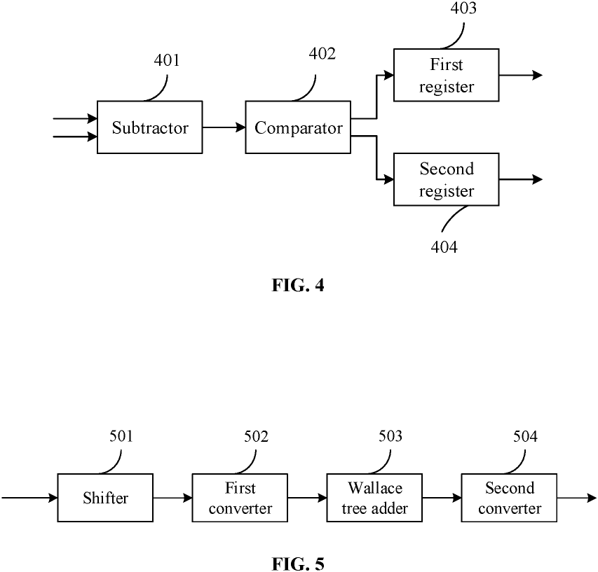

FIG. 4 shows a schematic diagram of the filtering unit 202, which includes a subtractor 401, a comparator 402, a first register 403, and a second register 404.

The subtractor 401 is based on a result (a base exponent) of the identification unit 201 and is configured to obtain a difference value between each exponent and the base exponent. The subtractor 401 may be implemented in several ways. For example, the subtractor 401 includes N subtraction units to receive exponents of N floating point numbers in an identification cluster and the base exponent at a time and perform subtraction operations on exponents of all floating point numbers in the identification cluster and the base exponent to acquire the difference value between each exponent and the base exponent; or one floating point number in the identification cluster is input each time and a subtraction operation is performed on an exponent of this floating point number and the base exponent until all the floating point numbers in the identification cluster are operated. The present disclosure does not limit the implementation of the subtractor 401.

The comparator 402 receives the difference value from the subtractor 401 and is configured to judge whether the difference value is less than a threshold. In other words, the comparator 402 judges whether a difference between an exponent of each floating point number and the base exponent is within a range of the threshold. The threshold may be any number, such as 32. If it is a floating-point number whose difference value is less than the threshold, the comparator 402 sends the floating-point number to the first register 403 for storage; if it is a floating-point number whose difference value is not less than the threshold, the comparator 402 sends the floating-point number to the second register 404 for storage. In other words, the comparator 402 divides the floating point numbers into two types according to sizes of exponents of the floating point numbers. The first register 403 is configured to store the floating point number whose difference value is less than the threshold, and the second register 404 is configured to store the floating point number whose difference value is not less than the threshold.

Since the exponent difference value of the floating point number stored in the first register 403 is less than the threshold, it is represented that the difference between the exponent of the floating point number in the first register 403 and the base exponent is not large. When accumulation is performed, it will not happen that mantissa bits lose too much precision when shifted because there is too much difference between exponent bit numbers. All floating point numbers in the first register 403 constitute an accumulation cluster in the present disclosure and are prepared to be accumulated in the addition unit 203. However, the difference value between the exponent of the floating point number stored in the second register 404 and the base exponent is too large. If the accumulation is performed, the mantissa bits lose too much precision when shifted. Therefore, the floating point number may not be sent to the addition unit 203 for accumulation in this phase. A processing method for the floating point number in the second register 404 will be explained later.

FIG. 5 shows a schematic diagram of the addition unit 203, which includes a shifter 501, a first converter 502, a Wallace tree adder 503, and a second converter 504.

The shifter 501 includes a plurality of barrel shift units. A barrel shift unit is a combined logical circuit, which has a plurality of data inputs and a plurality of data outputs and specifies how to move control inputs of data. The barrel shift units are configured to shift corresponding mantissas based on difference values respectively. First, the mantissas are restored and 0 is added after the mantissas. All shifted mantissas have threshold-minus-one bits, which means that each mantissa has 31 bits. More specifically, if an accumulation cluster includes 32 floating point numbers, the shifter 501 may include 32 shift units, where each shift unit is used to shift a mantissa bit of one floating point number in the first register 403. Since a base exponent is a maximum value among exponents of these 32 floating point numbers, exponents of floating point numbers in the accumulation cluster are all aligned to the base exponent, and mantissa bits of the floating point numbers are shifted accordingly. If a threshold is set as 32, there is no floating point number whose exponent difference value is greater than 32 in the accumulation cluster. Therefore, after shifting, mantissa bits of all the floating point numbers have threshold-minus-one bits; in other words, the mantissa bits of all the floating point numbers have 31 bits.

When the shift unit judges that bits removed by the shifted mantissas are all 0, under the principle of round-to-even of IEEE 754, the shift unit sets sticky bits of the shifted mantissas as 0. When the shift unit judges that the bits removed by the shifted mantissas are all 1, the shift unit sets the sticky bits as 1. At this point, the shifter 501 completes the exponent alignment of all the floating point numbers in the accumulation cluster.

The first converter 502 is configured to convert the shifted mantissas into complements. Since the Wallace tree adder 503 only supports complement operations, and operations before the shifter 501 are all completed in the form of original codes, the first converter 502 converts the shifted mantissas into the complements, so that the Wallace Tree adder 503 performs fixed point number accumulation operations.

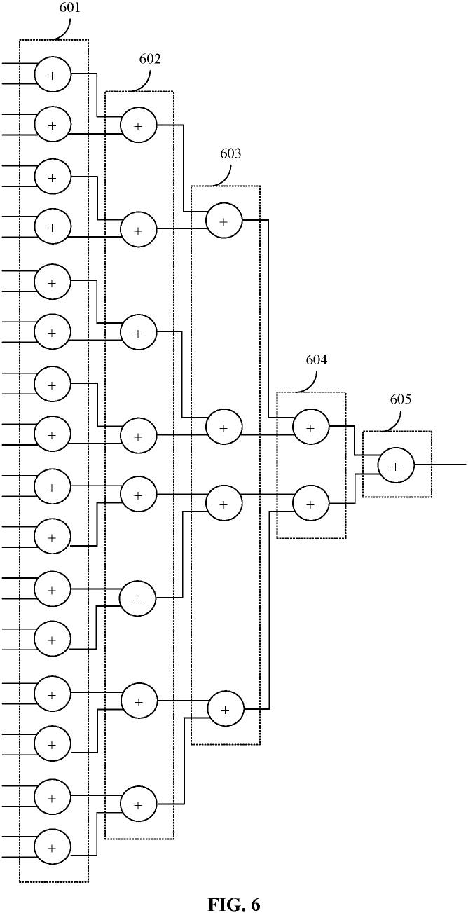

The Wallace tree adder 503 is configured to accumulate all complements in the accumulation cluster to generate an accumulation value complement. The Wallace tree adder 503 is a kind of multi-level two-input addition unit. FIG. 6 shows the Wallace tree adder 503, which is a five-level two-input addition unit, including a first-level addition unit 601, a second-level addition unit 602, a third-level addition unit 603, a fourth-level addition unit 604, and a fifth-level addition unit 605. Each level of addition unit adds fixed point numbers pairwise. Therefore, what the fifth-level addition unit 605 obtains is an accumulative total of 32 fixed point numbers.

The second converter 504 is configured to convert the accumulation value complement into an accumulation value original code. At this point, all the floating point numbers in the accumulation cluster are accumulated.

The accumulation apparatus continues to process floating point numbers in the second register 404. Going back to FIG. 2, the cluster unit 204 is configured to update the floating point numbers in the second register 404 to floating point numbers in the identification cluster. In other words, the cluster unit 204 uses the floating point numbers in the second register 404 to cover floating point numbers in the original identification cluster, so that floating point numbers in the updated identification cluster are not all to-be-accumulated floating point numbers but just floating point numbers that are not accumulated in the second register 404. The cluster unit 204 sends the updated identification cluster to the identification unit 201. The identification unit 201, the filtering unit 202, and the addition unit 203 perform identification, filtering, and accumulation operations based on the updated identification cluster. Such operations are repeated until all the floating point numbers enter the addition unit 203 for accumulation.

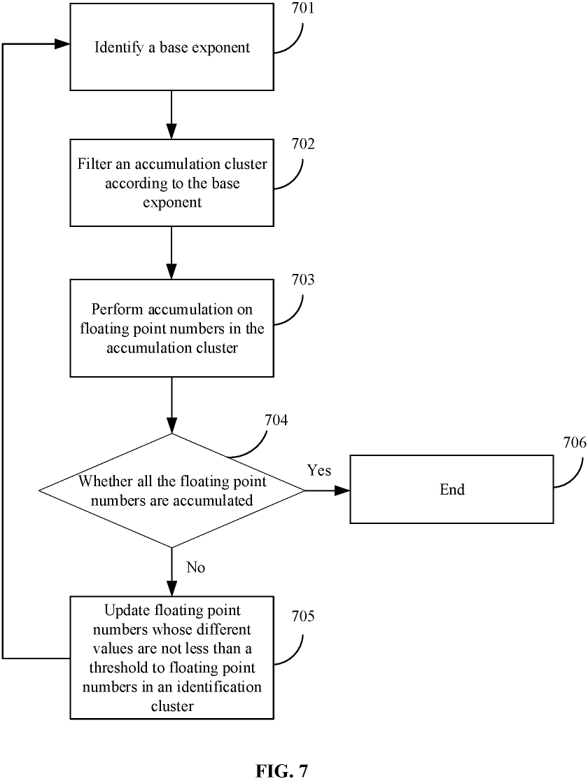

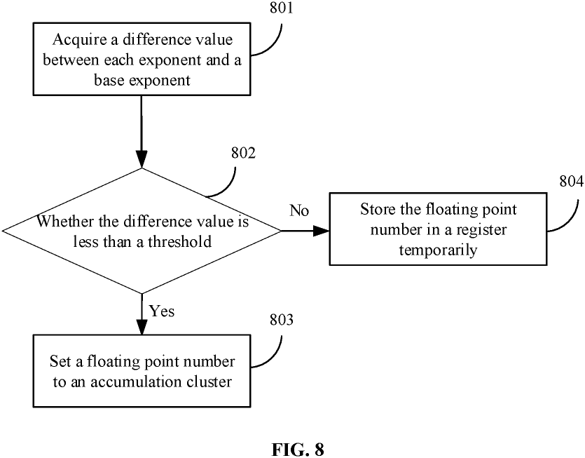

Another embodiment of the present disclosure shows a method for accumulating a plurality of floating point numbers in an identification cluster. FIG. 7 shows a flowchart of this method.

In a step 701, a base exponent is identified. In other words, a maximum value among exponents of all floating point numbers in the identification cluster is found out, and this exponent with the maximum value is used as the base exponent. A specific identification method is to compare the exponents of all the floating point numbers in the identification cluster pairwise and outputs the larger exponent.

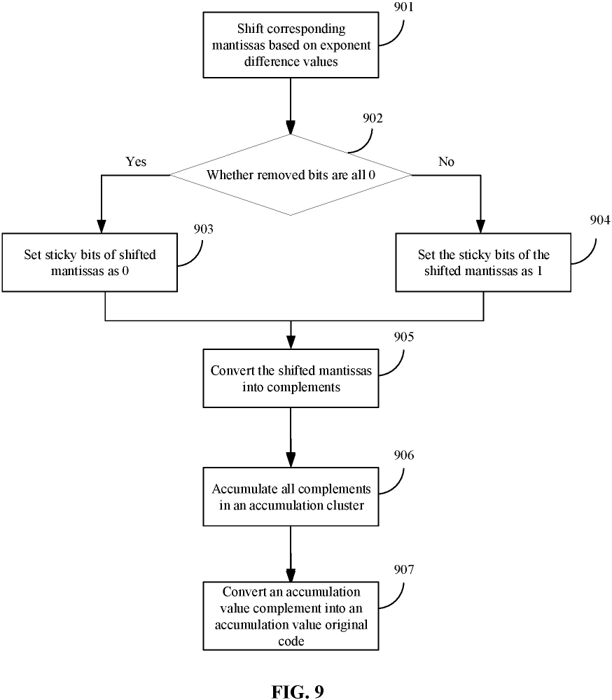

In a step 702, an accumulation cluster is filtered according to the base exponent, where the accumulation cluster is a subset of the identification cluster. Specific operations of this step are shown in FIG. 8.

In a step 801, based on the base exponent identified in the step 701, a difference value between each exponent and the base exponent is acquired. In a step 802, whether the difference value is less than a threshold is judged. In other words, whether a difference between an exponent of each floating point number and the base exponent is within a range of the threshold is judged, where the threshold may be any number. If it is a floating-point number whose difference value is less than the threshold, a step 803 is performed to set the floating point number to the accumulation cluster; if it is a floating-point number whose difference value is not less than the threshold, a step 804 is performed to temporarily store the floating-point number to a register. Since an exponent difference value of a floating point number in the accumulation cluster is less than the threshold, it is represented that a difference between an exponent of the floating point number and the base exponent is not large. When accumulation is performed, it will not happen that mantissa bits lose too much precision when shifted because there is too much difference between exponent bit numbers. However, a difference value between an exponent of a floating point number temporarily stored in the register and the base exponent is very large. If the accumulation is performed, the mantissa bits lose too much precision when shifted. Therefore, there is no accumulation in this phase.

In a step 703, floating point numbers in the accumulation cluster are accumulated. Specific operations of this step are shown in FIG. 9.

In a step 901, corresponding mantissas are shifted based on exponent difference values. First, the mantissas are restored and 0 is added after the mantissas. All shifted mantissas have threshold-minus-one bits. In a step 902, whether bits removed by the shifted mantissas are all 0 is judged; if the bits removed by the shifted mantissas are all 0, a step 903 is performed to set sticky bits of the shifted mantissas as 0; and if the bits removed by the shifted mantissas are not all 0, a step 904 is performed to set the sticky bits of the shifted mantissas as 1. At this point, the exponent alignment of all the floating point numbers in the accumulation cluster is completed.

In a step 905, the shifted mantissas are converted into complements. In a step 906, all complements in the accumulation cluster are accumulated to generate an accumulation value complement. In a step 907, the accumulation value complement is converted into an accumulation value original code. At this point, all the floating point numbers in the accumulation cluster are accumulated.

Next, a step 704 is performed to judge whether all the floating point numbers are accumulated. If not all the floating point numbers are accumulated, a step 705 is performed to update floating point numbers stored in the register to floating point numbers in the identification cluster. In other words, the floating point numbers in the register are updated to the floating point numbers in the identification cluster, so that floating point numbers in the updated identification cluster are not all to-be-accumulated floating point numbers but just floating point numbers that are not accumulated in the register. After the step 705, this process goes back to the steps 701, 702, and 703 to perform identification, filtering, and accumulation operations based on the updated identification cluster. Such operations are repeated until all the floating point numbers are accumulated, and then a step 706 is performed to end this process.

Another embodiment of the present disclosure shows a computer readable storage medium, on which computer program codes for accumulating a plurality of floating point numbers are stored. When the computer program codes are run by a processor, the method shown in FIG. 7, FIG. 8, and FIG. 9 is performed. In some implementation scenarios, an integrated unit may be implemented in the form of a software program unit. If the integrated unit is implemented in the form of the software program unit and sold or used as an independent product, the integrated unit may be stored in a computer-readable memory. Based on this, when the solution of the present disclosure is embodied in the form of a software product (such as a computer-readable storage medium), the software product may be stored in a memory. The software product may include several instructions used to enable a computer device (such as a personal computer, a server, or a network device, and the like) to perform part or all of steps of the method of the embodiments of the present disclosure. The memory includes but is not limited to an USB, a flash disk, a read only memory (ROM), a random access memory (RAM), a mobile hard disk, a magnetic disk, or an optical disc, and other media that may store a program code.

The present disclosure provides a floating point number accumulation solution. In this solution, exponents of floating point numbers are compared with a base exponent. Floating point numbers whose difference values are less than a threshold are accumulated. For floating point numbers whose difference values are not less than the threshold, the base exponent is found out again, and then based on the base exponent, the floating point numbers are compared and then accumulated until all the floating point numbers are accumulated. The solution of the present disclosure has a small circuit area, low power consumption, and high precision.

It is required to be explained that for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that for a part that is not described in detail in a certain embodiment of the present disclosure, reference may be made to related descriptions in other embodiments.

For specific implementations, according to the present disclosure and under the teaching of the present disclosure, those skilled in the art may understand that several embodiments disclosed in the present disclosure may be implemented through other methods that are not disclosed in the present disclosure. For example, for units in the electronic device or apparatus embodiment, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the direct or indirect coupling relates to a communication connection using an interface, where the communication interface may support electrical, optical, acoustic, magnetic, or other forms of signal transmission.

In the present disclosure, units described as separate components may or may not be physically separated. Components shown as units may or may not be physical units. The components or units may be located in a same position or distributed to a plurality of network units. Additionally, according to actual requirements, some or all of the units may be selected to achieve the purpose of the solution described in embodiments of the present disclosure. Additionally, in some scenarios, the plurality of units in the embodiments of the present disclosure may be integrated into one unit, or each of the units may be physically separated.

The foregoing may be better understood according to following articles:

Article A1. An accumulation apparatus configured to accumulate a plurality of floating point numbers in an identification cluster, where each floating point number is represented by an exponent and a mantissa, and the accumulation apparatus includes: an identification unit configured to identify a base exponent, where the base exponent is a maximum value among exponents of the plurality of floating point numbers; a filtering unit configured to filter an accumulation cluster based on the base exponent, where the accumulation cluster is a subset of the identification cluster; and an addition unit configured to perform accumulation on floating point numbers in the accumulation cluster.

Article A2. The accumulation apparatus of article A1, where the identification unit includes multiple levels of two-input comparators, each of which compares the exponents of the plurality of floating point numbers pairwise and outputs the larger exponent to a comparator of a next level.

Article A3. The accumulation apparatus of article A1, where the filtering unit includes: a subtractor configured to acquire a difference value between each exponent and the base exponent; a comparator configured to judge whether the difference value is less than a threshold; a first register configured to store a floating point number whose difference value is less than the threshold; and a second register configured to store a floating point number whose difference value is not less than the threshold, where the accumulation cluster includes all floating point numbers in the first register.

Article A4. The accumulation apparatus of article A3, further including: a cluster unit configured to update floating point numbers in the second register to floating point numbers in the identification cluster, where the identification unit, the filtering unit, and the addition unit perform identification, filtering, and accumulation operations based on the updated identification cluster.

Article A5. The accumulation apparatus of article A3, where the addition unit includes a plurality of shift units, which are respectively configured to shift corresponding mantissas based on difference values, where all shifted mantissas have threshold-minus-one bits.

Article A6. The accumulation apparatus of article A5, where, when the shift units judge that bits removed by the shifted mantissas are all 0, sticky bits of the shifted mantissas are set as 0, and when the shift units judge that the bits removed by the shifted mantissas are all 1, the sticky bits are set as 1.

Article A7. The accumulation apparatus of article A5, where the addition unit further includes a first converter configured to convert the shifted mantissas into complements.

Article A8. The accumulation apparatus of article A7, where the addition unit further includes a Wallace tree adder configured to accumulate all complements in the accumulation cluster to generate an accumulation value complement.

Article A9. The accumulation apparatus of article A8, where the addition unit further includes a second converter configured to convert the accumulation value complement into an accumulation value original code.

Article A10. A method for accumulating a plurality of floating point numbers in an identification cluster, where each floating point number is represented by an exponent and a mantissa, and the method includes: identifying a base exponent, where the base exponent is a maximum value among exponents of the plurality of floating point numbers; filtering an accumulation cluster based on the base exponent, where the accumulation cluster is a subset of the identification cluster; and performing accumulation on floating point numbers in the accumulation cluster.

Article A11. The method of article A10, where a step of identifying includes: comparing the exponents of the plurality of floating point numbers pairwise and outputting the larger exponent.

Article A12. The method of article A10, where a step of filtering includes: acquiring a difference value between each exponent and the base exponent; and setting a floating point number whose difference value is less than a threshold to the accumulation cluster.

Article A13. The method of article A12, further including: updating floating point numbers whose difference values are not less than the threshold to floating point numbers in the identification cluster, where steps of identifying, filtering, and accumulating are performed based on the updated identification cluster.

Article A14. The method of article A12, where a step of accumulating includes: shifting corresponding mantissas based on difference values, where all shifted mantissas have threshold-minus-one bits.

Article A15. The method of article A14, where the step of accumulating includes: judging whether bits removed by the shifted mantissas are all 0; setting sticky bits of the shifted mantissas as 0 if the bits removed by the shifted mantissas are all 0; and setting the sticky bits as 1 if the bits removed by the shifted mantissas are not all 0.

Article A16. The method of article A14, where the step of accumulating further includes: converting the shifted mantissas into complements.

Article A17. The method of article A16, where the step of accumulating further includes: accumulating all complements in the accumulation cluster to generate an accumulation value complement.

Article A18. The method of article A17, where the step of accumulating further includes: converting the accumulation value complement into an accumulation value original code.

Article A19. A computer readable storage medium, on which computer program codes for accumulating a plurality of floating point numbers are stored, where, when the computer program codes are run by a processing apparatus, the method of any one of articles A10-A18 is performed.

The embodiments of the present disclosure are described in detail above. The present disclosure uses specific examples to explain principles and implementations of the present disclosure. The descriptions of the above embodiments are only used to facilitate understanding of the method and core ideas of the present disclosure. Simultaneously, those skilled in the art may change the specific implementations and application scope of the present disclosure based on the ideas of the present disclosure. In summary, the content of this specification should not be construed as a limitation on the present disclosure.

1. An accumulation apparatus configured to accumulate a plurality of floating point numbers in an identification cluster, wherein each floating point number is represented by an exponent and a mantissa, the accumulation apparatus comprising:
an identification unit configured to identify a base exponent, wherein the base exponent is a maximum value among exponents of the plurality of floating point numbers;
a filtering unit configured to filter an accumulation cluster based on the base exponent, wherein the accumulation cluster is a subset of the identification cluster; and
an addition unit configured to perform accumulation on floating point numbers in the accumulation cluster.

2. The accumulation apparatus of claim 1, wherein the identification unit comprises multiple levels of two-input comparators, each of which compares the exponents of the plurality of floating point numbers pairwise and outputs the larger exponent to a comparator of a next level.

3. The accumulation apparatus of claim 1, wherein the filtering unit comprises:
a subtractor configured to acquire a difference value between each exponent and the base exponent;
a comparator configured to judge whether the difference value is less than a threshold;
a first register configured to store a floating point number whose difference value is less than the threshold; and
a second register configured to store a floating point number whose difference value is not less than the threshold, wherein
the accumulation cluster comprises all floating point numbers in the first register.

4. The accumulation apparatus of claim 3, further comprising:
a cluster unit configured to update floating point numbers in the second register to floating point numbers in the identification cluster, wherein
the identification unit, the filtering unit, and the addition unit perform identification, filtering, and accumulation operations based on the updated identification cluster.

5. The accumulation apparatus of claim 3, wherein the addition unit comprises a plurality of shift units, which are respectively configured to shift corresponding mantissas based on difference values, wherein all shifted mantissas have threshold-minus-one bits.

6. The accumulation apparatus of claim 5, wherein, when the shift units judge that bits removed by the shifted mantissas are all 0, sticky bits of the shifted mantissas are set as 0, and when the shift units judge that the bits removed by the shifted mantissas are all 1, the sticky bits are set as 1.

7. The accumulation apparatus of claim 5, wherein the addition unit further comprises a first converter configured to convert the shifted mantissas into complements.

8. The accumulation apparatus of claim 7, wherein the addition unit further comprises a Wallace tree adder configured to accumulate all complements in the accumulation cluster to generate an accumulation value complement.

9. The accumulation apparatus of claim 8, wherein the addition unit further comprises a second converter configured to convert the accumulation value complement into an accumulation value original code.

10. A method for accumulating a plurality of floating point numbers in an identification cluster, wherein each floating point number is represented by an exponent and a mantissa, the method comprising:
identifying a base exponent, wherein the base exponent is a maximum value among exponents of the plurality of floating point numbers;
filtering an accumulation cluster based on the base exponent, wherein the accumulation cluster is a subset of the identification cluster; and
performing accumulation on floating point numbers in the accumulation cluster.

11. The method of claim 10, wherein the identifying comprises:
comparing the exponents of the plurality of floating point numbers pairwise and outputting the larger exponent.

12. The method of claim 10, wherein the filtering comprises:
acquiring a difference value between each exponent and the base exponent; and
setting a floating point number whose difference value is less than a threshold to the accumulation cluster.

13. The method of claim 12, further comprising:
updating floating point numbers whose difference values are not less than the threshold to floating point numbers in the identification cluster,
wherein the identifying, the filtering, and the performing of the accumulation are performed based on the updated identification cluster.

14. The method of claim 12, wherein the performing of the accumulation comprises:
shifting corresponding mantissas based on difference values, wherein all shifted mantissas have threshold-minus-one bits.

15. The method of claim 14, wherein the performing of the accumulation comprises:
judging whether bits removed by the shifted mantissas are all 0;
setting sticky bits of the shifted mantissas as 0 if the bits removed by the shifted mantissas are all 0; and
setting the sticky bits as 1 if the bits removed by the shifted mantissas are not all 0.

16. The method of claim 14, wherein the performing of the accumulation further comprises:
converting the shifted mantissas into complements.

17. The method of claim 16, wherein the performing of the accumulation further comprises:
accumulating all complements in the accumulation cluster to generate an accumulation value complement.

18. The method of claim 17, wherein the performing of the accumulation further comprises:
converting the accumulation value complement into an accumulation value original code.

19. A non-transitory computer readable storage medium, on which computer program codes for accumulating a plurality of floating point numbers are stored, wherein, when the computer program codes are run by a processing apparatus, the method of claim 10 is performed.
